(19) United States
(12) Patent Application Publication
(10) Pub. No.: US 2010/0015828 A1
(43) Pub. Date: Jan. 21, 2010

(54) SPEAKER CONNECTING SEAT

(76) Inventor: Wei-Tang Uen, Kaohsiung County (TW)

Correspondence Address: Wei-Tang Uen, 235 Chung - Ho Box 8-24, Taipei, 235, TW

(21) Appl. No.: 12/420,812

(22) Filed: Jul. 7, 2009

Related U.S. Application Data
(63) Continuation-in-part of application No. 12/176,449, filed on Jul. 21, 2008, now Pat. No. 7,581,971.

(51) Int. Cl. H01R 29/00

(52) U.S. Cl. 439/166

(57) ABSTRACT

A speaker connecting seat mainly includes a retainer and an adjusting sleeve. Separated paths are formed inside the retainer for respectively receiving a first conducting component and a second conducting component so as to provide different conductions and simplify the complicated wiring. By selectively connecting one of the two ends of the adjusting sleeve to a contacting sheet formed to one of the conducting components, the adjusting sleeve can be slid into a connecting portion of another conducting component so as to conveniently switch a conducting path.

The present invention is a continuation in part of U.S. patent application Ser. No. 12/176,449, which is assigned to the inventor of the present invention. Thus the contents of the invention U.S. patent application Ser. No. 12/176,449 is incorporated into the present invention as a part of the present invention.

### FIELD OF THE INVENTION

The present invention relates to connecting seat, and particular to a speaker connecting seat for conducting speaker signals.

### DESCRIPTION OF THE PRIOR ART

Speakers are developed by advanced electronic audio technology for transforming electric signals to sounds. It is also an important component to output sounds for electronics such as earphone, stereo system, communication equipment, multimedia computer, electronic translator, and equipments for transmitting or transforming sound signals. The electric signals can be processed by a main frame into phases such as high pitch, low pitch, mono or stereo sound, and others. Audiences usually use various main frames connected by connectors or terminals for different signals to output sounds through a same set of speaker.

While a lot of sound terminals are connected to the speaker, a corresponding quantity of connector is needed. It is complicated and causes higher cost, and it also damages an outer appearance for such circumstance. A jumper is needed for connecting various sets of positive and negative terminals. Such jumper will cause higher impendence for signal transmission and sound distortions will thus happened.

Therefore, the inventor of the present invention once provided a Taiwan patent with application no. 096128495 and published no. 200908483 about a connecting device capable of switching between a single conduction and multi-conduction by a single fixing cap. The invention has a main body of cable connecting seat for an electronic equipment. The main body is an assembly consisting of fixing cap and socket. The assembly has three main portions. The first portion is cable connecting portion having threaded socket for fixing cable by directly insertion or with the fixing cap. An end of the fixing cap is conductive end and the other one is an insulated end so as to perform a single conduction or separated conduction by turning the fixing cap. The second portion is conducting portion consisting of at least two sets of device with an insulator between. The device has an end contacting the cable and locking the fixing cap and another end connecting the electronic equipment attached to the invention. When a cable is conducted to the conducting portion and the conductive ends of the fixing cap, various conducting portions will be conducted to the same cable through the conductive ends of the fixing caps conducted together. On the contrary, when different cables are connected to each conducting portion and the insulated end of the fixing caps, the cables will be conducted to each conducting portion separately. The third portion is attaching portion serving to attach the invention to a proper position of a stereo system. The invention will be fixed by a engaging unit so that it will not be moved while plugging or unplugging cables.

Based on the mentioned patent, a China patent of no. 200810134454.2 and a U.S. Pat. No. 12176449 are applied. Although the mentioned patents have superior functions, there is improvement remained to develop about the simplification of components.

### SUMMARY OF THE PRESENT INVENTION

Accordingly, a speaker connecting seat according to the present invention includes a retainer. Separated tunnels are formed inside the retainer for respectively receiving a first conducting component and a second conducting component. The first conducting component is extended to a first end portion of the rod body and is thus connected to a connecting portion. The second conducting component is extended to the first end portion of the rod body and is thus formed as a contacting sheet. An adjusting sleeve have a through tube body. An insulated ring and a conductive ring are respectively arranged to two ends of the adjusting sleeve. By selectively connecting one of the two ends of the adjusting sleeve to the contacting sheet of the second conducting component, the adjusting sleeve can be slid into the connecting portion of the first conducting component so as to conveniently switch a conducting path.

The separated tunnels formed inside the retainer allow two independent signals transmitted through the first conducting component and the second conducting component so as to save spaces and improve an outer appearance of a stereo system.

Moreover, a blocking sheet is arranged to an inner wall of the adjusting sleeve for providing a compressing force to the inserted connecting portion so that the stability of the connection as well as the sound transmission are improved. Also, the blocking sheet can prevent damage to the system by avoiding accidental plug of unnecessary cable to a same path.

The blocking sheet of the present invention not only serves to compressing the connecting portion but also stabilize the transmitted signal. For such definitions and purposes, the shape and mechanism of the blocking sheet are not confined within a specific style.

### BRIEF DESCRIPTION OF THE DRAWINGS

FIG. 1 is a pictorial drawing showing a disassembly of the present invention.

FIG. 2 is a pictorial drawing showing an assembly of the present invention.

FIG. 3 is a pictorial drawing of a flat type first conducting component of the present invention.

FIG. 4 is a cross-section view of the assembly of the present invention with a cable plugged therein.

FIG. 5 is a cross-section view of the half assembly of the present invention.

FIG. 6 is a cross-section view of the assembly of the present invention.

FIG. 7 is a cross-section view of the present invention showing a male terminal being blocked by a blocking sheet.

FIG. 8 is a cross-section view of the present invention showing a male terminal being received inside thereof.

FIG. 9 is an assembly drawing of the present invention with a different embodiment of a second conducting component.

FIG. 10 is a cross-section view showing another embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

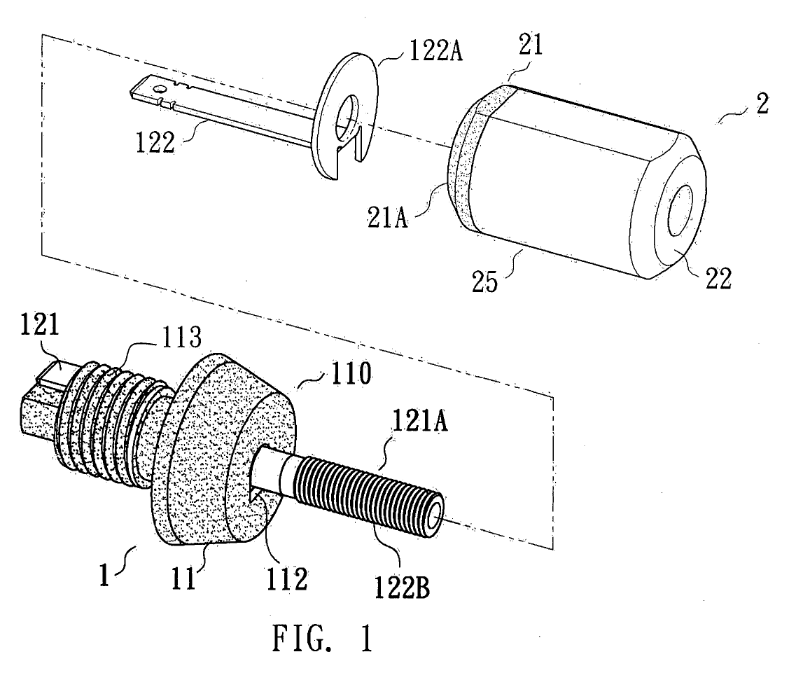

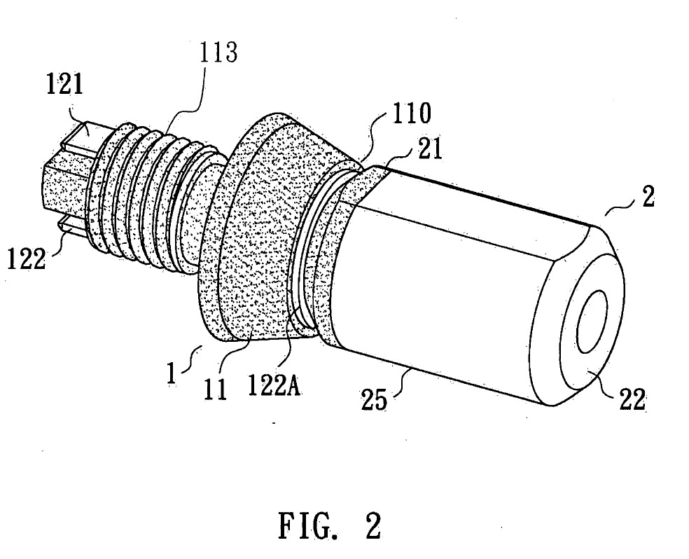

Referring to FIGS. 1 and 2, a speaker connecting seat includes the following components.

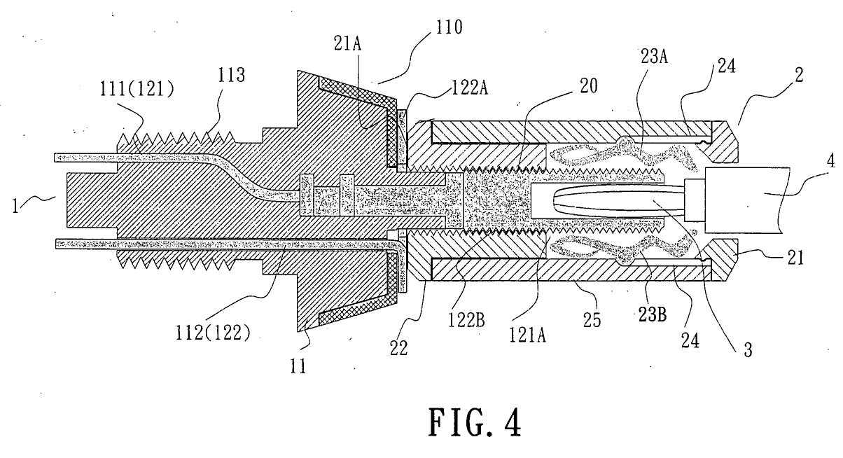

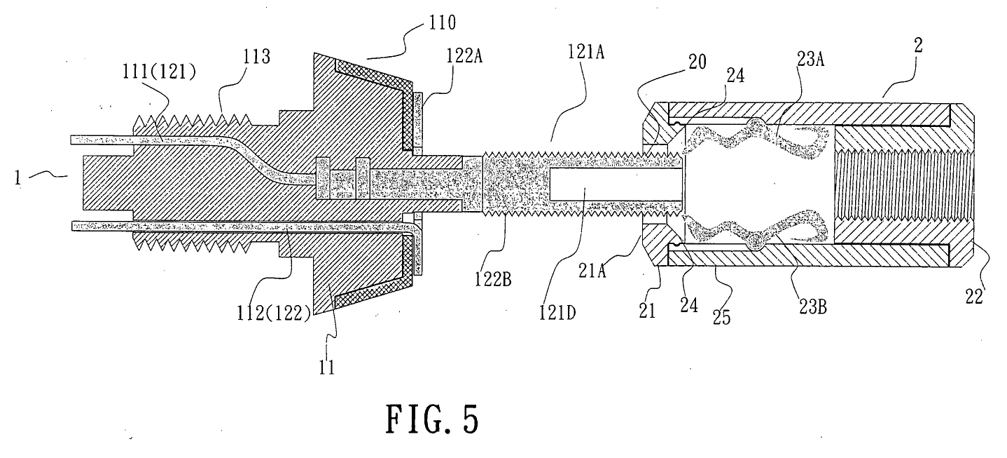

A retainer 1 consists of a rod body 11 made of an insulated material. A rear end of the rod body 11 has a thread 113. With reference to FIGS. 4 and 5, a first tunnel 111 and a second tunnel 112 are formed inside of the rod body 11. A first conducting component 121 and a second conducting component 122 are arranged to the first tunnel 111 and a second tunnel 112 respectively. The two tunnels 111 and 112 are separated from each other so that the first conducting component 121 and the second conducting component 122 are capable of conducting it's own signal independently within the retainer 1. Space for wiring is saved so as to improve an outer appearance of a stereo system.

However, the first conducting component 121 is extended to a first end portion 110 of the rod body 11 and is thus connected to a connecting portion 121A. An outer end of the connection portion 121A has a socket 121D for receiving an external terminal as shown in FIG. 5. The connecting portion 121A serves to connect and conduct for the first conducting component 121. The second conducting component 122 is extended to the first end portion 110 of the rod body 11 and is thus formed as a contacting sheet 122A. The contacting sheet 122A can be shaped corresponding to the first end portion 110 of the rod body 11. The contacting sheet 122A serves to connect and conduct for the second conducting component 122.

An adjusting sleeve 2 has a through tube body 25. An insulated ring 21A and a conductive ring 22 are arranged to two ends of the adjusting sleeve 2 respectively. The two ends of the adjusting sleeve 2 can be selectively faced to the contacting sheet 122A of the second conducting component 122. The insulated ring 21A is preferably formed by an insulated piece 21 inserted into the tube body 25 so that an outer end of the insulated piece 21 is formed as an insulated ring 21A. In another embodiment of the present invention which is not shown in the Figures, an insulated attachment is attached to the end of the tube body 25 instead to form a said insulated ring.

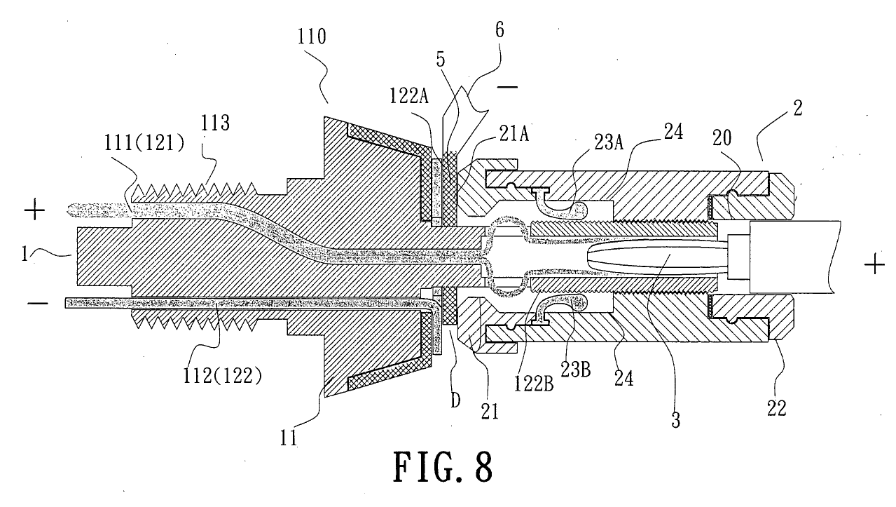

The second conducting component 122 and the conducted signal are isolated by sliding the adjusting sleeve 2 into the rod body 11 with the insulated ring 21A contacting the contacting sheet 122A of the second conducting component 122. The signal will be transmitted only through the connecting portion 121A of the first conducting component 121 to an external plugged male terminal 3 and a cable 4 connected to the male terminal 3. Referring to FIG. 8, the contacting sheet 122A of the second conducting component 122 will be conducted to other cable 6 through a Y-terminal 5 under compression by the insulated ring 21A of the adjusting sleeve 2.

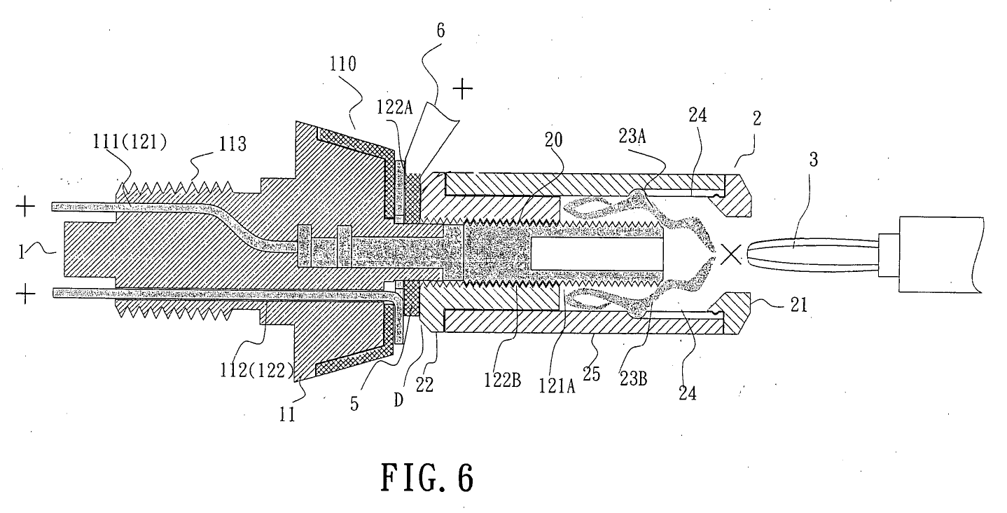

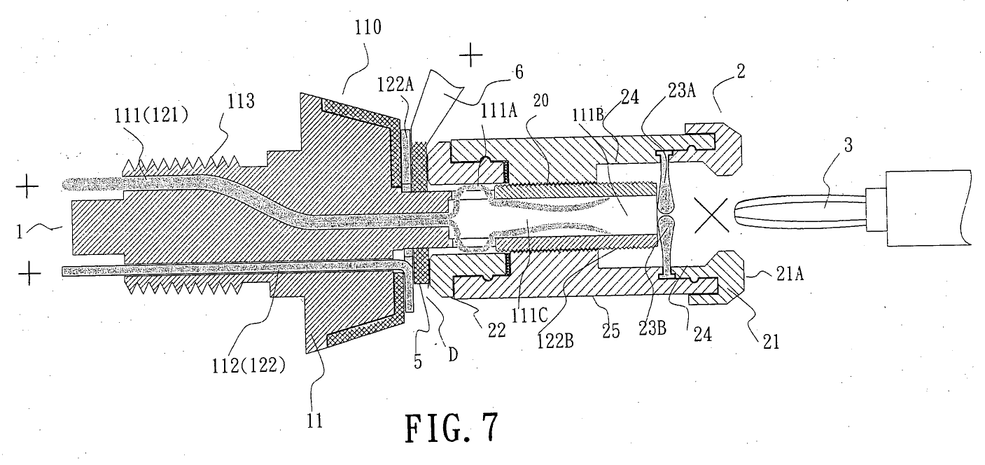

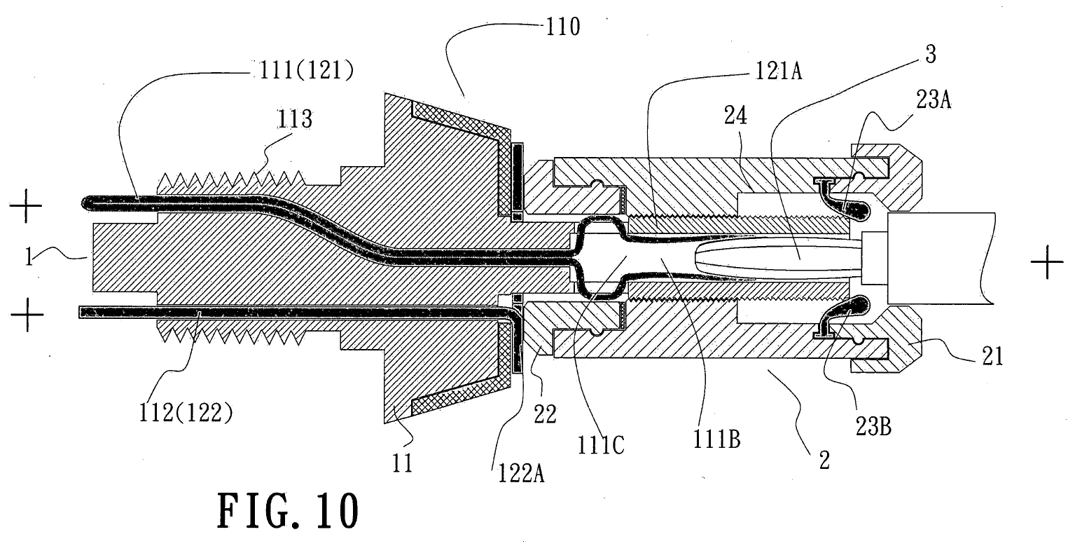

While the second conducting component 122 and the first conducting component 121 are needed to conduct to a same single cable, the adjusting sleeve 2 is slid into the rod body 11 with the conductive ring, 22 contacting the contacting sheet 122A of the second conducting component 122. A signal source from a Y-terminal 5 of a cable 6 can be conducted to the contacting sheet 122A of the second conducting component 122 by inserting the Y-terminal 5 into a gap between the conductive ring 22 and the contacting sheet 122A as shown in FIGS. 6 and 7. Or, with reference to FIGS. 4 and 10, the cable 4 with the male terminal 3 conducted to the connecting portion 121A extending from the first conducting component 121 can be conducted to the first conducting component 121 and the second conducting component 122. Therefore, the first conducting component 121 and the second conducting component 122 can be conducted to the cable 6 or the cable 4 in the same time.

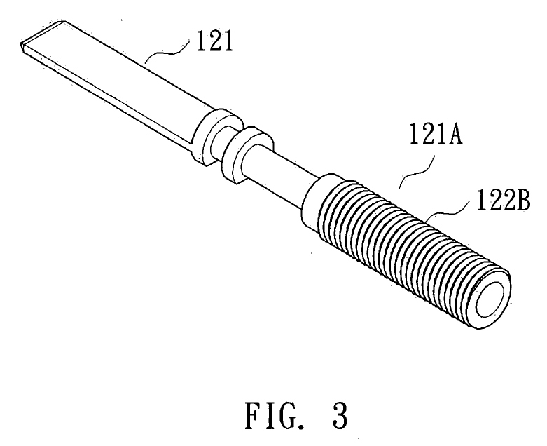

The first conducting component 121 and the second conducting component 122 can be differently shaped for different shapes of the first tunnel 111 and a second tunnel 112. Referring to FIG. 3, the first conducting component 121 is flat so that the first tunnel 111 is also formed flat. While in FIG. 4, the first tunnel 111 inside the rod body 11 is bent but the second tunnel 112 is straight.

Furthermore, with reference to FIG. 1, a preferable embodiment of the connecting portion 121A of the present invention is shown. An outer thread 122B is formed to an outer surface of the connecting portion 121A, and a corresponding inner thread 20 is formed to an inner wall of the adjusting sleeve 2 as shown in FIG. 4. The connecting portion 121A also can be a simple bolt capable of directly inserting into the adjusting sleeve 2.

Moreover, the inner thread 20 of the adjusting sleeve 2 can be formed to an inner wall of the conductive ring 22 (as shown in FIG. 6) or an inner wall of the insulated piece 21. The inner thread 20 can be formed without extra work to the adjusting sleeve 2, the manufacturing process will thus be simplified and the cost is also saved. Obviously, the inner thread 20 can be also formed directly to an inner wall of the adjusting sleeve 2 as shown in FIG. 7.

With reference to FIGS. 6 and 7, a first blocking sheet 23A is pivoted to an inner wall 24 of the adjusting sleeve 2. The first blocking sheet 23A serves to block an external cable from plugging into the connecting portion 121A of the first conducting component 121 while a cable is already conducted to the gap D between the conductive ring 22 and the contacting sheet 122A so as to prevent accidental damage to the system. Referring to FIGS. 4 and 10, while the conductive ring 22 of the adjusting sleeve 2 is pushed to contact the contacting sheet 122A of the second conducting component 122 without having another cable connected the gap D between the conductive ring 22 and the contacting sheet 122A, the connecting portion 121A extending from the first conducting component 121 will push the blocking sheets 23A and 23B away so as to allow a cable to plug in. The plugged cable will be conducted to the connecting portion 121A of the first conducting component 121 and also the second conducting component 122 through the conductive ring 22.

In FIG. 8, a reverse installation of the adjusting sleeve 2 is shown than that in the FIGS. 7 and 6. With reference to FIG. 5, the blocking sheets 23A and 23B are formed as curves. The blocking sheets serve to block or receive depending on the positions of the connecting portion 121A, the blocking sheets can be made of elastic material or it can be pivoted to achieve such purpose. The shape and mechanism of the blocking sheets of the present invention are not confined within a certain type.

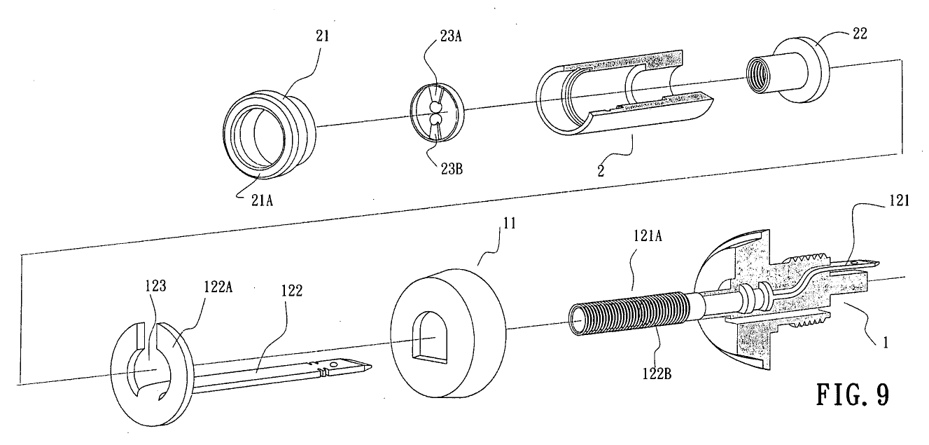

With reference to FIG. 9, an embodiment of the contacting sheet 122A extending from the second conducting component 122 is illustrated. The contacting sheet 122A is formed as approximate C shape, and the second conducting component 122 is extended from a portion of an inner fringe of the ring. The contacting sheet 122A can also be a ring with a cut and the second conducting component 122 is extended from a fringe of the cut as shown in FIG. 1. The shape of the contacting sheet 122A can be various but it is preferably corresponding to that of the conductive ring 22 and the insulated ring 21A.

Referring to FIGS. 10 and 7, another embodiment of the connection between the first conducting component 111 and the connecting portion 121A are illustrated. The connecting portion 121A is hollow, and the first conducting component 121 is inserted into the hollow portion of the connecting portion 121A. An elastic curved portion of the first conducting component 121 is exposed outside the connecting portion 121A so as to contact the conductive ring 22 of the adjusting sleeve 2. The conductive ring 22 can be replaceable by a better conductive material or structure capable of controlling voltage and current by the needs. Referring to FIG. 10, a free end of the first conducting component 111 forms an opening 111B, a tunnel 111C is extended inwards from the opening 111B for receiving and conducting a terminal 3 plugged from the opening 111B so as to ensure the stability of the terminal as well as the signal carried by the cable connected to the terminal. Referring to FIG. 7, while the conductive ring 22 of the adjusting sleeve 2 is pushed to contact the contacting sheet 122A of the second conducting component 122 without having another cable connected the gap D between the conductive ring 22 and the contacting sheet 122A, the connecting portion 121A extending from the first conducting component 121 will move further inwards to push the blocking sheets 23A and 23B away so as to allow a terminal to plug. The plugged terminal will be conducted to the connecting portion 121A of the first conducting component 121 and also the second conducting component 122 through the conductive ring 22. Preferably, the blocking sheets 23A and 23B symmetrical arranged on the inner wall 24 of the adjusting sleeve 2 will provide symmetric suppressing forces to the received connecting portion 121A so as to have better stability between the adjusting sleeve 2 and the connecting portion 121A.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

[symbol]

What is claimed is:

1. A speaker connecting seat comprising:
a retainer having an insulated rod body;
the rod body having a first tunnel and a second tunnel therein and a first conducting component and a second conducting component being arranged inside the tunnels respectively;
the first conducting component extended to a first end portion of the rod body being connected to a connecting portion;
the second conducting component extended to the first end portion being formed as a contacting sheet;
an adjusting sleeve having a through tube body;
a insulated ring and a conductive ring being respectively arranged to two ends of the adjusting sleeve so as to selectively contact the contacting sheet of the second conducting component while the connecting portion being slid into the adjusting sleeve;

2. The speaker connecting seat as claimed in claim 1, wherein the connecting portion have an outer thread on an outer surface thereof and the adjusting sleeve have a corresponding inner thread on an inner wall thereof.

3. The speaker connecting seat as claimed in claim 1, wherein the insulated ring of the adjusting sleeve is formed by inserting a insulated piece into an end of the tube body of the adjusting sleeve.

4. The speaker connecting seat as claimed in claim 1, wherein the connecting portion have an outer thread on an outer surface thereof and the adjusting sleeve have a corresponding inner thread inside thereof; the insulated ring is formed by inserting a insulated piece into an end of the tube body; the said inner thread is formed to an inner wall of the insulated piece.

5. The speaker connecting seat as claimed in claim 1, wherein the shape of the contacting sheet is corresponding to the first end portion of the rod body of the retainer.

6. The speaker connecting seat as claimed in claim 1 wherein the first tunnel inside of the rod body has an upwards bent portion in a rear section thereof, and the second tunnel is formed straight.

7. The speaker connecting seat as claimed in claim 1, wherein a first blocking sheet is formed to an inner wall of the adjusting sleeve for receiving the connecting portion.

8. The speaker connecting seat as claimed in claim 1, wherein a first blocking sheet is formed to an inner wall of the adjusting sleeve, and a symmetric second blocking sheet is formed symmetrically to the inner wall so as to receive the connecting portion

9. The speaker connecting seat as claimed in claim 1, wherein the contacting sheet is formed as a ring.

10. The speaker connecting seat as claimed in claim 1, wherein the connecting portion is hollow, and the first conducting component is inserted into the hollow portion of the connecting portion; a free end of the first conducting component inside the connecting portion forms an opening, a tunnel is extended inwards from the opening.

11. The speaker connecting seat as claimed in claim 10, wherein an elastic curved portion of the first conducting component inserted into the connecting portion is exposed outside the connecting portion.

12. The speaker connecting seat as claimed in claim 10, wherein a blocking sheet is formed to an inner wall of the adjusting sleeve; the blocking sheet is against the hollow portion of the connecting portion so as to prevent a terminal from inserting into the hollow portion of the connecting portion; the prevention will be disabled while the adjusting sleeve is reversely slid into the connecting portion.

13. The speaker connecting seat as claimed in claim 10, wherein a blocking sheet is formed to an inner wall of the adjusting sleeve; the blocking sheet can be partially pushed away by the interference of the connecting portion so as to receive a terminal to plug into the hollow portion of the connecting portion.
